(19) United States
(12) Patent Application Publication
(10) Pub. No.: US 2025/0196251 A1
(43) Pub. Date: Jun. 19, 2025

(54) SYSTEMS AND METHODS FOR AN AC POWER GENERATOR DRIVEN BY A HYDRAULIC MOTOR

(71) Applicant: Illinois Tool Works Inc., Glenview, IL (US)

(72) Inventor: Jeffery R. Ihde, Sherwood, WI (US)

(21) Appl. No.: 18/973,937

(22) Filed: Dec. 9, 2024

Related U.S. Application Data
(60) Provisional application No. 63/610,199, filed on Dec. 14, 2023.

(51) Int. Cl. B23K 9/10

(52) U.S. Cl. CPC B23K 9/1012

(57) ABSTRACT

An example of an electrical generator system includes a hydraulic motor driven by a hydraulic power system. A generator coupled to and configured to be driven by the hydraulic motor. Power conversion circuitry is used to convert the power output from the generator to a synchronous alternating current (AC) power output.

### CROSS REFERENCE TO RELATED APPLICATIONS

This application is a Non-Provisional Patent Application claiming priority to U.S. Provisional Patent Application No. 63/610,199 entitled “Systems And Methods For An Ac Power Generator Driven By A Hydraulic Motor” filed Dec. 14, 2023, which is herein incorporated by reference in its entirety.

### BACKGROUND

Conventional welding-type power supplies provide power for welding-type tools. Some such power supplies are coupled to an engine that drives an electric generator. In some cases, the engine can be limited in how power is delivered to the generator, providing an intermittent and/or variable power output to the electric generator. Further, some systems may not provide a direct connection to mechanical power from the engine. A system that allows a variety of output regulators to power the electric generator is therefore desirable.

### SUMMARY

Systems and methods are disclosed of electrical generator system that includes a hydraulic motor driven by a hydraulic power system, substantially as illustrated by and described in connection with at least one of the figures, as set forth more completely in the claims.

### BRIEF DESCRIPTION OF THE DRAWINGS

FIG. 1 illustrates a block diagram of an example power generator driven by a hydraulic motor, in accordance with aspects of this disclosure.

FIG. 2 illustrates a block diagram of another example power generator driven by a hydraulic motor, in accordance with aspects of this disclosure.

FIG. 3 illustrates a block diagram of example control circuitry for the power generators driven by hydraulic motors of FIGS. 1 and 2, in accordance with aspects of this disclosure.

FIG. 4 illustrates example method of operating an example power generator driven by a hydraulic motor, in accordance with aspects of this disclosure.

The figures are not necessarily to scale. Where appropriate, similar or identical reference numbers are used to refer to similar or identical components.

### DETAILED DESCRIPTION

Disclosed are examples of methods and systems for driving a power system by a hydraulic motor synchronous. For example, disclosed is an alternating current (AC) generator system driven by a hydraulic motor that converts varying motor speeds to output fixed frequency power (e.g., 50 or 60 Hz). In some examples, the power system is a welding power supply, configured to provide mechanical and/or electrical power for one or more loads.

In some disclosed examples, a hydraulic motor is coupled to a generator/alternator. As motor speed changes the output frequency of the generator changes. This varying frequency output is input to a power converter (e.g., a synthetic auxiliary power converter or conversion circuitry), such as a 10 KW output converter. This conversion gives the user synchronous AC output power regardless of motor speed.

In some examples, the hydraulic power source is a hydraulic motor connected to a mechanical output, but a number of other hydraulic power sources providing sufficient output levels are considered. For instance, the hydraulic power source could have specifications for generating a given output torque (e.g., 3,000 or more pounds-per-square-inch (PSI)) and/or for a given output rate (e.g., 3,000 PSI Gallons per-minute). However, smaller or greater output values are considered within the scope of this disclosure, depending on the particular application.

In some examples, the generator can be connected to a bi-directional converter, such that an electrical input can be used to drive the hydraulic motor.

Some engine powered generators, such as direct drive AC welder/generators, generate power and provide an output level that changes with engine speed. As disclosed herein, the generator is driven by a hydraulic motor, which is less sensitive to changes in engine speed. For instance, the hydraulic pump provides an output based on pressure of a hydraulic fluid. As the hydraulic pump reaches a threshold pressure level, the pump provides an output to drive the hydraulic motor within a substantially narrow range. The result is a more consistent output, which can be used to generate mechanical as well as electrical power.

As disclosed herein, the hydraulic motor can be connect to and configured to drive an electrical generator, which is employed to power one or more auxiliary loads, such as to power welding-type tools (e.g., welding-type torches, wire feeders, plasma torches, etc.), recharge energy storage devices, and power auxiliary loads (e.g., wire feeders). The hydraulic motor can be in use for extended periods of time, even as power demand changes, or if no power demand exists. When the system is not actively providing power to a load, and the pressure within the hydraulic motor exceeds a threshold level, the power source can reduce output (e.g., idle an engine-to reduce wear on the system, fuel consumption, exhaust, noise, etc.), while being capable of a quick resumption of power output on demand.

Advantageously, and by contrast to conventional systems, the presently disclosed system provides a wider operating range by employing a hydraulic motor to power the loads of a welding system. Further, little or no speed regulation is needed (e.g., from an engine input). As a result, generator efficiencies are enhanced at higher operating speeds.

Accordingly, the use of a hydraulic motor advantageously provides a more consistent output from a variable speed input to drive one or more loads of a power system.

In some disclosed examples, the system includes control circuitry to monitor one or more operating characteristics of the system, such as corresponding to a power input to, and/or power output from, the hydraulic motor (e.g., input or output speed, pressure, torque, resistance, as a list of non-limiting examples). Based on the operating characteristic, the control circuitry may trigger an automatic response on the system. This response can include adjusting an operating parameter associated with one or more of the power source (e.g., adjusting the engine speed), the welder/generator (e.g., an output demand), and/or one or more loads (e.g., an air compressor).

As used herein, the term “hydraulic motor” includes any device capable of converting fluid pressure into linear or rotary motion. Example hydraulic motors operate by pressurizing fluid from a hydraulic pump into a rotary motion as a motor output shaft is driven by the pressurized fluid acting on one or more components of the hydraulic motor (e.g., gears, pistons, etc.).

As used herein, the term “hydraulic power system” includes a system having a motor, a fluid reservoir, and a pump. The hydraulic power system applies hydraulic pressure to one or more devices to drive motors, shafts, cylinders, and/or other parts of the hydraulic power system.

As used herein, the term “hydraulic pump” describes a device to convert mechanical power into hydraulic energy, thereby serving as a source for mechanical power output, such as to a hydraulic motor.

As used herein, the terms “welding-type system” and/or “welding system,” includes any device capable of supplying power suitable for welding, plasma cutting, induction heating, CAC-A and/or hot wire welding/preheating (including laser welding and laser cladding), including inverters, converters, choppers, resonant power supplies, quasi-resonant power supplies, etc., as well as control circuitry and other ancillary circuitry associated therewith.

As used herein, the terms “welding-type power” and/or “welding power” refer to power suitable for welding, plasma cutting, induction heating, CAC-A and/or hot wire welding/preheating (including laser welding and laser cladding). As used herein, the term “welding-type power supply” and/or “power supply” refers to any device capable of, when power is applied thereto, supplying welding, plasma cutting, induction heating, CAC-A and/or hot wire welding/preheating (including laser welding and laser cladding) power, including but not limited to inverters, converters, resonant power supplies, quasi-resonant power supplies, and the like, as well as control circuitry and other ancillary circuitry associated therewith.

As used herein, “power conversion circuitry” and/or “power conversion circuits” refer to circuitry and/or electrical components that convert electrical power from one or more first forms (e.g., power output by a generator) to one or more second forms having any combination of voltage, current, frequency, and/or response characteristics. The power conversion circuitry may include safety circuitry, output selection circuitry, measurement and/or control circuitry, and/or any other circuits to provide appropriate features.

As used herein, a “circuit,” or “circuitry,” includes any analog and/or digital components, power and/or control elements, such as a microprocessor, digital signal processor (DSP), software, and the like, discrete and/or integrated components, or portions and/or combinations thereof.

As used herein, the term “torch,” “welding torch,” “welding tool” or “welding-type tool” refers to a device configured to be manipulated to perform a welding-related task, and can include a hand-held welding torch, robotic welding torch, gun, or other device used to create the welding arc.

As used herein, the term “welding mode,” “welding process,” “welding-type process” or “welding operation” refers to the type of process or output used, such as current-controlled (CC), voltage-controlled (CV), pulsed, gas metal arc welding (GMAW), flux-cored arc welding (FCAW), gas tungsten arc welding (GTAW), shielded metal arc welding (SMAW), spray, short circuit, and/or any other type of welding process.

As used herein, the term “welding program” includes at least a set of welding parameters for controlling a weld. A welding program may further include other software, algorithms, processes, or other logic to control one or more welding-type devices to perform a weld.

As used herein, the term “auxiliary device” or “auxiliary tool” refers to a variety of devices configured to receive power from a generator or other power output, and can include lighting, batteries, or other devices powered by electricity.

As used herein, the terms “first” and “second” may be used to enumerate different components or elements of the same type, and do not necessarily imply any particular order.

As used herein, the terms “coupled,” “coupled to,” and “coupled with,” each mean a structural and/or electrical connection, whether attached, affixed, connected, joined, fastened, linked, and/or otherwise secured. As used herein, the term “attach” means to affix, couple, connect, join, fasten, link, and/or otherwise secure. As used herein, the term “connect” means to attach, affix, couple, join, fasten, link, and/or otherwise secure.

As used herein, the terms “welding parameter” includes one or more of voltage, current, power, wire feed speed, gas flow rate, pulse rate, workpiece thickness, workpiece material type, electrode type, welding process, travel speed, arc length, or joint type, as a list of non-limiting examples.

The term “power” is used throughout this specification to describe both mechanical and electrical power for convenience, but also includes related measures such as energy, current, voltage, resistance, conductance, and enthalpy. For example, controlling “power” may involve controlling voltage, current, energy, resistance, conductance, and/or enthalpy, and/or controlling based on “power” may involve controlling based on voltage, current, energy, resistance, conductance, and/or enthalpy.

The terms “control circuit,” “control circuitry,” and/or “controller,” as used herein, may include digital and/or analog circuitry, discrete and/or integrated circuitry, microprocessors, digital signal processors (DSPs), and/or other logic circuitry, and/or associated software, hardware, and/or firmware. Control circuits or control circuitry may be located on one or more circuit boards that form part or all of a controller, and are used to control a welding process, a device such as a power source or wire feeder, and/or any other type of welding-related system.

As used herein, the term “processor” means processing devices, apparatus, programs, circuits, components, systems, and subsystems, whether implemented in hardware, tangibly embodied software, or both, and whether or not it is programmable. The term “processor” as used herein includes, but is not limited to, one or more computing devices, hardwired circuits, signal-modifying devices and systems, devices and machines for controlling systems, central processing units, programmable devices and systems, field-programmable gate arrays, application-specific integrated circuits, systems on a chip, systems comprising discrete elements and/or circuits, state machines, virtual machines, data processors, processing facilities, and combinations of any of the foregoing. The processor may be, for example, any type of general purpose microprocessor or microcontroller, a digital signal processing (DSP) processor, an application-specific integrated circuit (ASIC), a graphic processing unit (GPU), a reduced instruction set computer (RISC) processor with an advanced RISC machine (ARM) core, etc. The processor may be coupled to, and/or integrated with a memory device.

As used, herein, the term “memory” and/or “memory device” means computer hardware or circuitry to store information for use by a processor and/or other digital device. The memory and/or memory device can be any suitable type of computer memory or any other type of electronic storage medium, such as, for example, read-only memory (ROM), random access memory (RAM), cache memory, compact disc read-only memory (CDROM), electro-optical memory, magneto-optical memory, programmable read-only memory (PROM), erasable programmable read-only memory (EPROM), electrically-erasable programmable read-only memory (EEPROM), a computer-readable medium, or the like. Memory can include, for example, a non-transitory memory, a non-transitory processor readable medium, a non-transitory computer readable medium, non-volatile memory, dynamic RAM (DRAM), volatile memory, ferroelectric RAM (FRAM), first-in-first-out (FIFO) memory, last-in-first-out (LIFO) memory, stack memory, non-volatile RAM (NVRAM), static RAM (SRAM), a cache, a buffer, a semiconductor memory, a magnetic memory, an optical memory, a flash memory, a flash card, a compact flash card, memory cards, secure digital memory cards, a microcard, a minicard, an expansion card, a smart card, a memory stick, a multimedia card, a picture card, flash storage, a subscriber identity module (SIM) card, a hard drive (HDD), a solid state drive (SSD), etc. The memory can be configured to store code, instructions, applications, software, firmware and/or data, and may be external, internal, or both with respect to the processor 150.

FIG. 1 is a block diagram of an example power system 100. The example system 100 includes a hydraulic power system 106, which includes a power source 102 (e.g., an engine) to drive a hydraulic pump 104 (e.g., via a mechanical link 108, such as a power take-off (PTO)). A hydraulic output 110 of the hydraulic power system 106 and/or the hydraulic pump 104 can deliver a power output to a hydraulic motor 112 (e.g., via a hydraulic fluid, delivered via output 110).

The hydraulic motor 112 is connected to a generator 130 via a mechanical linkage 114 (e.g., a clutch, a transmission, a belt, etc.) to drive the generator. In some examples, the generator 130 is directly driven by the hydraulic motor 112. The generator 130 produces an electrical power output, which can be provided to power conversion circuitry 132, such as an individual or combined generator and/or welding power supply. In some examples, the power conversion circuitry 132 is further configured to provide an output to one or more auxiliary systems 140 (e.g., lighting, wire feeder, air compressor, battery charger, hydraulic pump, etc.). In some examples, the power conversion circuitry 132 provides power for a welding tool or torch 134 to perform a welding and/or cutting operation on a workpiece 136.

In some examples, the linkage 114 directly couples and/or integrates the generator 130 with the hydraulic motor 112. For instance, the generator/hydraulic motor may be enclosed within a single housing or otherwise physically coupled.

In some examples, the hydraulic power system 106 is mounted to and/or otherwise incorporated with a vehicle, such as a work truck (not shown). The vehicle can include a power source 120, such as the vehicle engine or a mounted engine directly connected to the hydraulic pump 104, and/or to drive the PTO 108 to drive the hydraulic pump 10. The hydraulic pump 104 may be incorporated with the power source 102, such as enclosed within a common housing and/or within the vehicle itself. The hydraulic output 110 of the hydraulic pump 104 drives the hydraulic motor 112, which can therefore drive the generator 130 at a more consistent speed in comparison to conventional, engine driven power sources.

In some additional or alternative examples, the engine is part of a power generation system separate from the vehicle, and can have a capacity up to 65 horsepower and up to 3,600 revolutions per minute (RPM), while in other examples the engine has a capacity up to 25 horsepower and 2,500 RPMs, as a list of non-limiting examples.

In some examples, the power conversion circuitry 132 can be and/or be incorporated within an electric welder (e.g., welding power supply). The converted power can be regulated to provide power to a welding tool 134 for arc welding and/or cutting. The power conversion circuitry 132 can additionally or alternatively regulate the power output for one or more auxiliary devices 140, such an auxiliary tool, a grinder, a wrench, lighting, and/or a compressor.

In some examples, the system 100 is configured such that the generator 130, coupled to and configured to be driven by the hydraulic motor 112, provides a power output for the power conversion circuitry 132 to convert the power output from the generator 130 to a synchronous AC power output. In some examples, the power conversion circuitry 132, which receives a variable AC input from the generator 130, is configured to generate the synchronous AC power output to a welding tool 134 and/or auxiliary device and/or tool 140.

In some examples, the regulated power output can be described as a synthetic auxiliary output, with the power delivered to the auxiliary device 140 and/or the welding tool 134 convert power over a range of voltage and/or current output curves, over a range of values (e.g., 120 V-240 V, 15 A-500 A, at 50-60 Hz).

In some examples, the hydraulic pump 104 has a range of operating pressures, which can be between approximately 2,500 and 4,500 pounds per square inch (PSI).

In disclosed examples, the engine 102 has a capacity up to 65 horsepower and/or up to 3,600 revolutions per minute (RPM). In some examples, the capacity up to 25 horsepower and 2,500 RPM, although other power capacity engines are considered. The engine 102 may operate on four or fewer cylinders (e.g., a two-cylinder piston engine), although other engine types are considered.

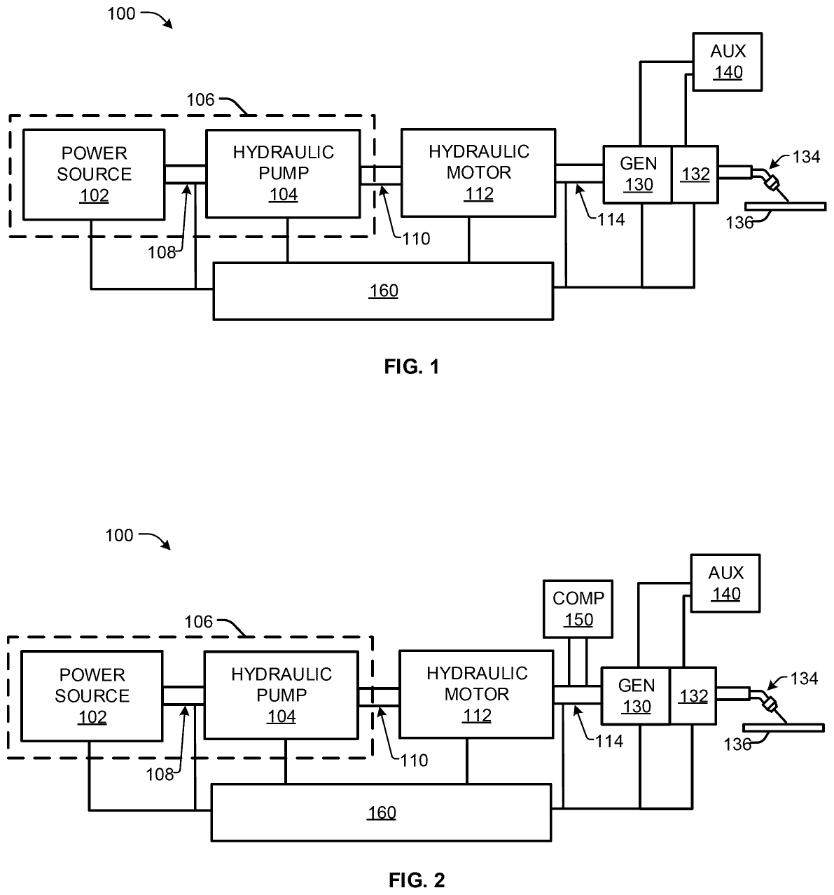

FIG. 2 is a block diagram of another example power system 100A. The example system 100A includes a number of similar components to that of system 100, with the addition of another load 150 to the mechanical linkage 114. In the example of FIG. 2, the load 150 is an air compressor, which is turned by the mechanical power output via linkage 114 from the hydraulic motor 112. Although illustrated as a single linkage to drive multiple outputs, in some examples the hydraulic motor 112 may provide multiple linkages for multiple direct connections with two or more loads.

In the example of FIGS. 1 and 2, control circuitry 160 is connected to one or more of the power source 102 (e.g., engine), the hydraulic pump 104, the mechanical link 108, the hydraulic power system 106, the hydraulic motor 112, the mechanical linkage 114, the generator 130, the power conversion circuitry 132, the tool 134, the auxiliary load, and/or the load 150, as a list of non-limiting examples.

In some disclosed examples, the control circuitry 160 monitors one or more operating characteristics of the system 100 or the various components, such as corresponding to a power input to, and/or power output from, the hydraulic motor 112 (e.g., input or output speed, pressure, torque, resistance, as a list of non-limiting examples). Based on the operating characteristic, the control circuitry 160 may trigger an automatic response on one or more components of the system 100. This response can include adjusting an operating parameter associated with one or more of the power source 102 (e.g., adjusting the engine speed), the generator 130 (e.g., an output demand), and/or one or more loads (e.g., power conversion circuitry 132, auxiliary load 140, load 150, etc.). Furthermore, one or more linkages 108, 110, 114 may be adjusted to completely or partially engage or disengage in response to the one or more operating characteristics.

For example, control of the system 100 can be regulated by the control circuitry 160. The control circuitry 160 can adjust conversion of the output from the hydraulic motor 112 and/or the output from the hydraulic system 106. Such an adjustment may be enacted to optimize mechanical and/or electrical generation, as only a few potential desired results.

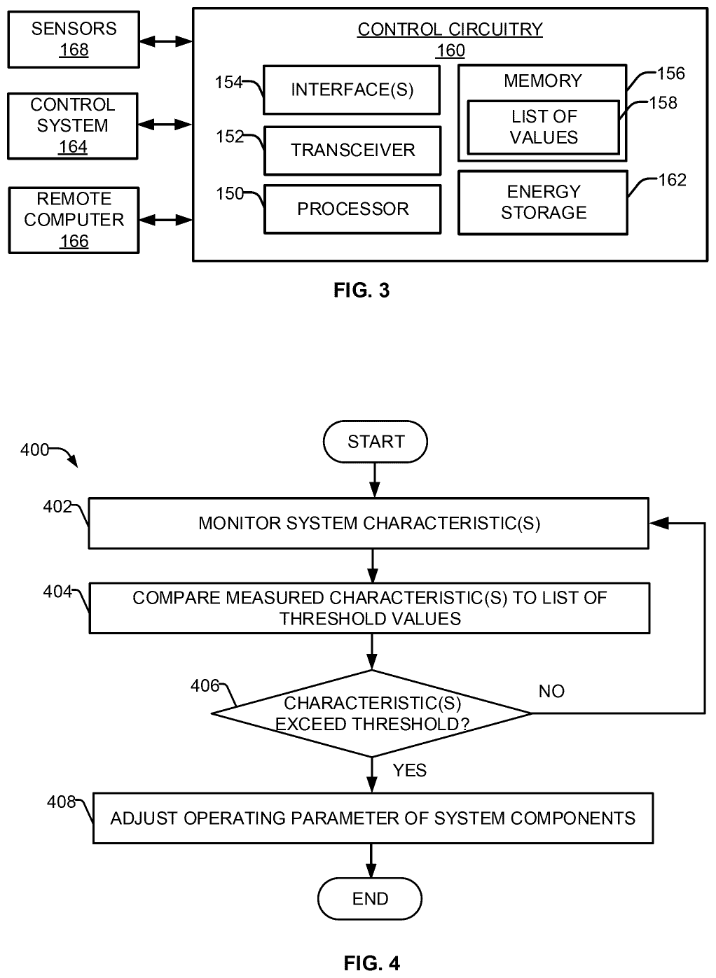

FIG. 3 is a block diagram of the example control circuitry 160, which can be configured as a microcontroller, or to include a processor 150, to perform as a programmable logic circuit, a system-on-chip, a programmable logic device, and/or any other type of logic circuit. The control circuitry 160 can be included in one or more components of the system 100 (e.g., the power source 102, the generator 130, the power conversion circuitry 132, the tool 134, etc.), and/or be implemented as a remote computer or control device 166 provided in FIG. 3.

In some examples, the controller 160 can include a transceiver to communicate with one or more of the power source 102, the generator 130, the power conversion circuitry 132, and/or the tool 134. One or more interfaces 154 can be included with or connected to the control circuitry 160, to provide a communications link with one or more sensors 168, a control system 164 (e.g., of the power source 102, the generator 130, the power conversion circuitry 132, the tool 134, etc.), and/or a remote computer 166 (e.g., a remote control, a laptop, smart phone, etc.). The sensors 168 can be arranged at one or more components or locations about the system, and can be configured to monitor a variety of system operating characteristics, including, among other things, power, torque, voltage, current, resistance, temperature, engine speed, pressure, etc.

In some examples, the control circuitry 160 includes a memory storage device 156, and/or an energy storage device 162. For example, information related to operating characteristics, pressure measurements, power trends, welding processes, etc., can be stored in a list 158, chart, library, etc., within memory 156.

Based on a determination at the control circuitry 160 (e.g., an analysis of a change in welding process, power demand, a comparison of the changes to stored data, etc.) the control circuitry 160 commands an adjustment to one or more of the power source 102, the generator 130, the power conversion circuitry 132, the tool 134, a linkage, etc. For instance, the control circuitry 160 can compare the monitored characteristic(s) to a list of threshold characteristics (stored as list 158) corresponding to operation of the system 100. Based on the comparison, the control circuitry 160 can adjust an operating parameter of one or more of the hydraulic motor, the generator, the various loads, and/or the torch. In this manner, the system 100 can automatically react to changes in the operational requirements of the hydraulic motor or other system component.

In examples, information regarding system usage trends based on the monitored characteristics can be analyzed and stored (e.g., in memory 156). These stored trends can be used to predict when the control circuitry 160 should control a connection between the hydraulic motor 112 and the system 106 and/or the generator 130 in response to a change of welding operation, power draw, pressure, torque, etc. The usage trends can be specific to the system 100, or be loaded onto the memory 156 (via interfaces 154) to reflect usage trends of other systems.

In some examples, the system(s) 100 can include an interface 154 (e.g., a switch, a computer input device, etc.) to provide options for an operator to control the system 100. Additionally or alternatively, the interface 154 can include a list of operations with either a set of known parameters, or a list of operations that correspond to a learned operation. Thus, the known or historical actions and conditions during a particular operation will aid in the determination of when to adjust an operating parameter of the system 100.

Additionally or alternatively, one or more component may be in direct communication with another component, for example, one or more of the various system components (e.g., the control circuitry 160) can be directly linked to any one or more of the other components (e.g., the generator 130, the power conversion circuitry 132, the tool 134, etc.) to facilitate communication.

FIG. 4 is a flowchart illustrating example method 400 of operating a welding-type power system, for example, the system 100 and the hydraulic motor 112 of FIGS. 1 and 2. The method 400 of FIG. 4 may be implemented by control circuitry (e.g., control circuitry 160) by executing machine-readable instructions, such as stored on a non-transitory machine-readable storage device (e.g., memory 156).

At block 402 of method 400, control circuitry (e.g., the control circuitry 160) monitors one or more characteristics associated with one or more of the system. For example, the control circuitry can receive characteristics corresponding to temperature, power output, a torque, a pressure level (e.g., in the hydraulic motor), as a list of non-limiting examples. For instance, the characteristics may be a commanded value of the characteristic and/or a measured value (via one or more sensors at the power conversion circuitry 132, the tool 134, the hydraulic motor 112, etc.).

At block 404, the control circuitry compares the monitored characteristic(s) to a list of threshold characteristics corresponding to operation of the system. For example, the characteristic(s) may be a discrete value, a range of values, and/or a change in values (e.g., over time). The threshold values may correspond to values associated with changes in demand for power output. Thus, the control circuitry compares the characteristic(s) to the threshold values to determine if the system operation should be adjusted, such as engaging or disengaging a linkage, and/or increasing power output (e.g., activating and/or connecting to the power source) at block 406.

If the control circuitry determines the monitored characteristic(s) do not cross a given threshold, the method returns to block 402 to continue to monitor the system for changes. If the control circuitry determines the monitored characteristic(s) has crossed a given threshold, the method proceeds to block 408 to adjust an operating parameter of one or more of the system components, such as the power source, the generator, the tool, and/or a linkage.

The present devices and/or methods may be realized in hardware, software, or a combination of hardware and software. The present methods and/or systems may be realized in a centralized fashion in at least one computing system, processors, and/or other logic circuits, or in a distributed fashion where different elements are spread across several interconnected computing systems, processors, and/or other logic circuits. Any kind of computing system or other apparatus adapted for carrying out the methods described herein is suited. A typical combination of hardware and software may be a processing system integrated into a welding power supply with a program or other code that, when being loaded and executed, controls the welding power supply such that it carries out the methods described herein. Another typical implementation may comprise an application specific integrated circuit or chip such as field programmable gate arrays (FPGAs), a programmable logic device (PLD) or complex programmable logic device (CPLD), and/or a system-on-a-chip (SoC). Some implementations may comprise a non-transitory machine-readable (e.g., computer readable) medium (e.g., FLASH memory, optical disk, magnetic storage disk, or the like) having stored thereon one or more lines of code executable by a machine, thereby causing the machine to perform processes as described herein. As used herein, the term “non-transitory machine readable medium” is defined to include all types of machine-readable storage media and to exclude propagating signals.

As utilized herein the terms “circuits” and “circuitry” refer to physical electronic components (i.e., hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code.

As utilized herein, “and/or” means any one or more of the items in the list joined by “and/or.” As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y and z.” As utilized herein, the term “exemplary” means serving as a non-limiting example, instance, or illustration. As utilized herein, the terms “e.g.,” and “for example” set off lists of one or more non-limiting examples, instances, or illustrations. As utilized herein, circuitry is “operable” to perform a function whenever the circuitry comprises the necessary hardware and code (if any is necessary) to perform the function, regardless of whether performance of the function is disabled or not enabled (e.g., by a user-configurable setting, factory trim, etc.).

While the present method and/or system has been described with reference to certain implementations, it will be understood by those skilled in the art that various changes may be made and equivalents may be substituted without departing from the scope of the present method and/or system. For example, block and/or components of disclosed examples may be combined, divided, re-arranged, and/or otherwise modified. In addition, many modifications may be made to adapt a particular situation or material to the teachings of the present disclosure without departing from its scope. Therefore, the present method and/or system are not limited to the particular implementations disclosed. Instead, the present method and/or system will include all implementations falling within the scope of the appended claims, both literally and under the doctrine of equivalents.

What is claimed is:

1. An electrical generator system, comprising:
a hydraulic motor driven by a hydraulic power system: and
a generator coupled to and configured to be driven by the hydraulic motor, the generator to provide a power output to a tool.

2. The system of claim 1, wherein the generator is directly coupled to the hydraulic motor.

3. The system of claim 1, wherein the generator is coupled to the hydraulic motor via a shaft.

4. The system of claim 1, wherein the hydraulic power system comprises a hydraulic pump configured to receive power from a power source, the hydraulic pump configured to provide a hydraulic output to drive the hydraulic motor.

5. The system of claim 1, further comprising power conversion circuitry to convert the power output from the generator to a regulated power output.

6. The system of claim 5, wherein the tool is configured to receive power from the power conversion circuitry or the generator.

7. The system of claim 5, wherein the tool is a welding tool, the regulated power output from the power conversion circuitry configured to provide welding power for the welding tool.

8. The system of claim 1, wherein the tool is an auxiliary tool comprising one or more of a grinder, a wrench, lighting, or a compressor.

9. The system of claim 1, wherein the system is mounted to a vehicle that includes the power source, such that a power take off connected to the power source drives the hydraulic pump.

10. An electrical generator system, comprising:
a hydraulic motor driven by a hydraulic power system:
a generator coupled to and configured to be driven by the hydraulic motor; and
power conversion circuitry to convert the power output from the generator to a synchronous alternating current (AC) power output.

11. The system of claim 10, wherein the hydraulic power system includes a hydraulic pump to receive power from a power source and transfer a hydraulic output to the hydraulic motor.

12. The system of claim 11, wherein the hydraulic pump has an operating pressure between approximately 2,500 and 4,500 pounds per square inch (PSI).

13. The system of claim 10, wherein the power conversion circuitry is configured to receive a variable AC input from the generator and output the synchronous AC power output.

14. The system of claim 10, further comprising a welding torch connected to and configured to draw power from the power conversion circuitry.

15. The system of claim 10, wherein the system is a vehicle mounted auxiliary power system comprising an enclosure, with one or more of the engine, the welder/generator, the hydraulic motor, the hydraulic pump, or the power conversion circuitry arranged within the enclosure.

16. The system of claim 10, wherein the generator is directly coupled to the hydraulic motor.

17. The system of claim 10, wherein the generator is coupled to the hydraulic motor via a shaft.

18. The system of claim 10, further comprising power conversion circuitry to convert the power output from the generator to a regulated power output.

19. The system of claim 18, wherein the tool is configured to receive power from the power conversion circuitry or the generator.

20. The system of claim 10, wherein the system is mounted to a vehicle that includes the power source, such that a power take off connected to the power source drives the hydraulic pump.
